(19) United States
(12) Patent Application Publication
(10) Pub. No.: US 2023/0367617 A1
(43) Pub. Date: Nov. 16, 2023

(54) SUGGESTING FEATURES USING MACHINE LEARNING

(71) Applicant: Slack Technologies, LLC, San Francisco, CA (US)

(72) Inventors: Aaron Maurer, New York, NY (US); Andrew Timmons, Emeryville, CA (US); Kyle Jablon, Long Island City, NY (US); Fiona Condon, Brooklyn, NY (US)

(21) Appl. No.: 17/744,009

(22) Filed: May 13, 2022

(51) Int. Cl. G06F 9/451; G06F 11/34

(52) U.S. Cl. CPC G06F 9/453; G06F 11/3438; G06F 11/3476; G06N 20/00

(57) ABSTRACT

In association with a communication platform, a machine learning component may determine affordances to provide to users, where affordances describe features provided by the communication platform. The machine learning component is trained using log data representing interactions and features used (or not used) by users. In some examples, the log data is associated with members of one or more groups while, in other examples, the log data is associated with all of the users of the communication platform. To determine an affordance, the machine learning component analyzes an interaction between a user and the communication platform. Based on the analysis, the machine learning component determines a relationship between the interaction and a feature. The machine learning component then generates the affordance to include information about the feature. Additionally, a user interface then provides the affordance to the user, such as in proximity to the feature.

### TECHNICAL FIELD

A communication platform may leverage a network-based computing system to enable users to exchange data. In an example, users of the communication platform may communicate with other users via channels, direct messages, and/or other virtual spaces. A channel, direct message, and/or other virtual space may be a data route used for exchanging data between and among systems and devices associated with the communication platform. For example, a channel may be established between and among various user computing devices (e.g., clients), allowing the user computing devices to communicate and share data between and among each other over one or more networks. That is, in some examples, the communication platform can be a channel-based platform and/or hub for facilitating communication between and among users. In some examples, data associated with a channel, a direct message, and/or other virtual space can be presented via a user interface. The data can include message objects, such as text, file attachments, emojis, and/or the like that are each posted by individual users of the communication platform. Users are then able to use features of the user interface in order to better communicate using the communication platform.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example environment for performing techniques described herein.

FIG. 2 illustrates an example user interface associated with a communication platform, as described herein, wherein an affordance describing a feature is provided via the user interface.

FIG. 3 illustrates an example user interface associated with a communications platform, as described herein, where an affordance provides details about a feature of a document being provided by the user interface.

FIG. 4 illustrates example user interfaces associated with a communication platform, as described herein, where two members of a group are provided with a same affordance while working in a collaborative space.

FIG. 5 illustrates an example process for training a machine learning component, as described herein.

FIG. 6 illustrates an example process for utilizing a machine learning component to determine an affordance that includes information about a feature associated with a communication platform, as described herein.

### DETAILED DESCRIPTION

In association with a communication platform, user interfaces may present data associated with a channel, a direct message, a virtual space, and/or the like. Some examples of this disclosure are related to using machine learning component(s) to determine affordances to provide via the user interfaces in order to increase the levels of engagement between users and the communication platform. To increase or otherwise direct levels of engagement, the affordances may describe features that the communication platform provides to the users. As described herein, a feature associated with the communication platform may include, but is not limited to, turning on notifications, downloading an application, joining a communication channel, identifying members of the communication channel, joining a workspace, identifying members of the workspace, updating a profile associated with the user account, sending a message, formatting a message (e.g., formatting text, adding emojis, etc.), editing a message that has already been sent, searching for received messages, setting a status, and/or the any other function that a user may perform with the communication platform. In the examples of the present disclosure, the machine learning component(s) determine the affordances to provide in order to maximize the level of user engagement with the features of the communication platform. In some examples, the machine learning component(s) determine the affordances to direct user engagement to receive benefits of the communication platform, such as reduced messaging, improved processing or memory usage, deduplication of storage, and other technical benefits.

For example, server(s) may initially train the machine learning component(s) using one or more techniques. To train the machine learning component(s), the server(s) may use log data representing interactions with users of the communication platform. As described herein, an interaction may include, but is not limited to, sending a message, sending a threshold number of messages (e.g., two messages, five messages, ten messages, etc.), receiving a message, receiving a threshold number of messages, opening a collaborative function associated with the communication platform, opening a document, opening the user interface, inputting an identifier of a member associated with a group, joining the communication platform (e.g., joining a communication channel, joining a workspace, etc.), utilizing the communication platform a specific number of times (e.g., one time, five, times, ten times, etc.), utilizing a feature of the communication platform a specific number of times (e.g., one time, five, times, ten times, etc.), utilizing the communication platform for a specific an amount of time (e.g., one hour, one day, one week, one month, etc.), utilizing a features of the communication platform for a specific amount of time (e.g., one hour, one day, one week, one month, etc.), responding to a message with a graphical element, joining an audio or video communication, initiating an audio or video communication, and/or the like. The log data may further indicate features that the users utilizes when interacting with the communication platform. For a first example, the log data may indicate that users that sent their fifth message using the communication platform (e.g., an interaction) finally started using a feature associated with messages, such as tools for changing the formatting of the message. For a second example, the log data may indicate that a large number of users that join workspaces (e.g., an interaction) also used the feature for identifying other members of the workspaces.

In some examples, the log data is associated with more than one group. For example, the log data may represent interactions that members of more than one group performed while collaborating with one another using the communication platform. By training the machine learning component(s) using such log data, the machine learning component(s) may better identify features that are important to all users of the communication platform. In some examples, the log data is associated with a single group. For example, the log data may represent the interactions that members of the group performed while collaborating with one another using the communication platform. By training the machine learning component(s) using such log data, the machine learning component(s) may better identify features that are important to the members of the group. Still, in some examples, the log data is associated with similar types of users. For example, the log data may represent the interactions that users, which the server(s) determine as being similar to one another (or a same type as), performed while collaborating using the communication platform. By training the machine learning component(s) using such log data, the machine learning component(s) may better identify features that are important to a type of user. As described herein, users may be similar to one another based on the users utilizing similar features, performing similar interactions, utilizing the communication platform for at least a threshold amount of time, purchasing features associated with the communication platform, and/or the like.

To train the machine learned component(s), the server(s) may input the log data into the machine learned component(s). The machine learning component(s) may then analyze the log data in order to identify relationships between features that were used by users when performing different types of interactions with the communication platform. For a first example, the machine learning component(s) may analyze the log data in order to identify that a large number of users that send messages also used different tools for formatting the messages. As such, the machine learning component(s) may identify a relationship between sending messages (e.g., an interaction) and using formatting tools (e.g., a feature). For a second example, the machine learning component(s) may analyze the log data in order to identify that users that purchase features associated with the communication platform tend to join workspaces earlier than users that do not purchase the features. As such, the machine learning component(s) may identify a relationship between joining workspaces early (e.g., an interaction) and purchasing features of the communication platform (e.g., a feature).

Additionally, in some examples, the machine learning component(s) may analyze the log data in order to identify times that the users use features when performing the interactions with the communication platform. For a first example, the machine learning component(s) may analyze the log data in order to identify that a large number of users use the tools for formatting messages after sending at least five messages. As such, the machine learning component(s) may identify a relationship between sending at least a fifth message (e.g., an interaction) and using formatting tools (e.g., a feature). For a second example, the machine learning component(s) may analyze the log data in order to identify that a large number of users use the tools for formatting messages after using the communication platform for at least a week. As such, the machine learning component(s) may also identify a relationship between using the communication platform for at least a week (e.g., an interaction) and again using formatting tools (e.g., a feature).

After training the machine learning component(s), the server(s) may then use the machine learning component(s) in order to determine affordances to provide to users while utilizing the communication platform. As described herein, an affordance may include, but is not limited to, a prompt, a message, a notification, a graphic, content, an image, a video, an audio file, and/or the like that suggests and/or describes a feature. For a first example, an affordance may include a prompt that includes text that suggests that a user use a feature. For a second example, an affordance may include an image representing how to use a feature. For a third example, an affordance may include a video depicting a user using a feature. Still, for a fourth example, an affordance may include an audio file representing one or more words describing how to use a feature.

To determine an affordance for a user, the server(s) may receive, from a device associated with a user, an indication of an interaction for the user with the communication platform. For a first example, the interaction may include the user drafting a message for another user. The server(s) may then analyze the interaction using the machine learning component(s) in order to determine the affordance for the user. For instance, and using this first example, if there is a relationship between drafting messages (e.g., an interaction) and using formatting tools (e.g., a feature), then the machine learning component(s) may determine the affordance as describing features for formatting messages using tools. For a second example, the interaction may include the user drafting his or her fifth message using the communication platform. The server(s) may then again analyze the interaction using the machine learning component(s) in order to determine the affordance of the user. For instance, and using this second example, if there is a relationship between drafting a fifth message (e.g., an interaction) and using formatting tools (e.g., a feature), then the machine learning component(s) may again determine the affordance as describing the feature for formatting messages using tools.

In some example, and as described above, the machine learning component(s) may be trained in order to be specific to a group of users and/or a type of users. This way, the machine learning component(s) are able to provide affordances that are more significant to a specific user. For a first example, the server(s) may receive an interaction from a user that is a member of a group, where the interaction includes the user joining the group. The server(s) may then analyze this interaction using machine learning component(s) that have been trained using log data associated with the group. For instance, and for this first example, if a large number of users that are members of the group join a workspace (e.g., a feature) after initially joining the group (e.g., an interaction), then the machine learning component(s) may identify a relationship between joining a workspace after initially joining a group. As such, the machine learning component(s) may determine an affordance that describes features associated with joining the workspace. This way, the user is able to better utilize the communication platform in order to participate with the other members of the group. In some examples, the server(s) may provide this same affordance for all members of the group when the members perform similar interactions.

For a second example, the server(s) may receive an interaction from a user that is new to the communication platform, where the interaction includes the user opening a user interface for the first time. The server(s) may then analyze this interaction using machine learning component(s) that have been trained using log data associated with users that have purchased features associated with the communication platform and/or continued to use the communication platform for long periods of time. For instance, and for this second example, if a large number of these users tend send messages when initially utilizing the communication platform while other users do not tend to send such messages, then the machine learning component(s) may identify a relationship between sending messages (e.g., a feature) when initially utilizing the communication platform (e.g., an interaction). As such, the machine learning component(s) may determine an affordance that describes features associated with sending messages. This way, the machine learning component(s) may provide the user with features that will help keep the user engaged with the communication platform.

The server(s) may then cause the affordance to be provided via the user interface of the user. For example, the server(s) may send, to the device associated with the user, data that causes the device to present the affordance along with the user interface. In some examples, the server(s) cause the device to present the affordance at a location on the user interface that is associated with the feature. For a first example, if the affordance describes the features associated with formatting a message, then the server(s) may cause the device to present the affordance over a portion of the user interface that is located proximate to the tools that the user uses to format the feature. For a second example, if the affordance describes the features directed to editing a message after the message has been sent, then the server(s) may cause the device to present the affordance over a portion of the user interface that is located proximate to the sent message. This way, the user is more easily able to identify the feature for which the affordance relates.

In some examples, such as when the user is a member of a group, the server(s) may cause the same affordance to be provided to other members of the group. This way, the server(s) are able to notify all of the members of the group about features that may be of importance to the group when the users are collaborating together. In some examples, the server(s) cause the same affordance to be provided to multiple members of the group at a same time, such as when the multiple users are collaboratively working on a document. In some examples, the server(s) cause the same affordance to be provided to multiple users at a respective time that each member performs a similar interaction. This way, the server(s) are able to notify the members of a same feature that is relevant to the same interaction being performed, but at a time that each user is performing the interaction.

In some examples, the server(s) may only provide affordances to users for a threshold period of time. For example, the server(s) may provide affordances to users for the first day, week, month, year, and/or the like that the users are using the communication platform. In some examples, the server(s) may only provide a threshold number of affordances to users. For example, the server(s) may only provide one affordance, five affordances, ten affordances, and/or the like to users. In some examples, the server(s) may only provide affordances to users until an event occurs. For a first example, the server(s) may only provide affordances to users until the server(s) determine that the users are able to use at least some of the relevant features of the communication platform. For a second example, the server(s) may only provide affordances to users until the users purchase one or more features associated with the communication platform. In any of these examples, the server(s) may perform such processes in order to only provide affordances to users when the users may need further help to identify features of the communication platform.

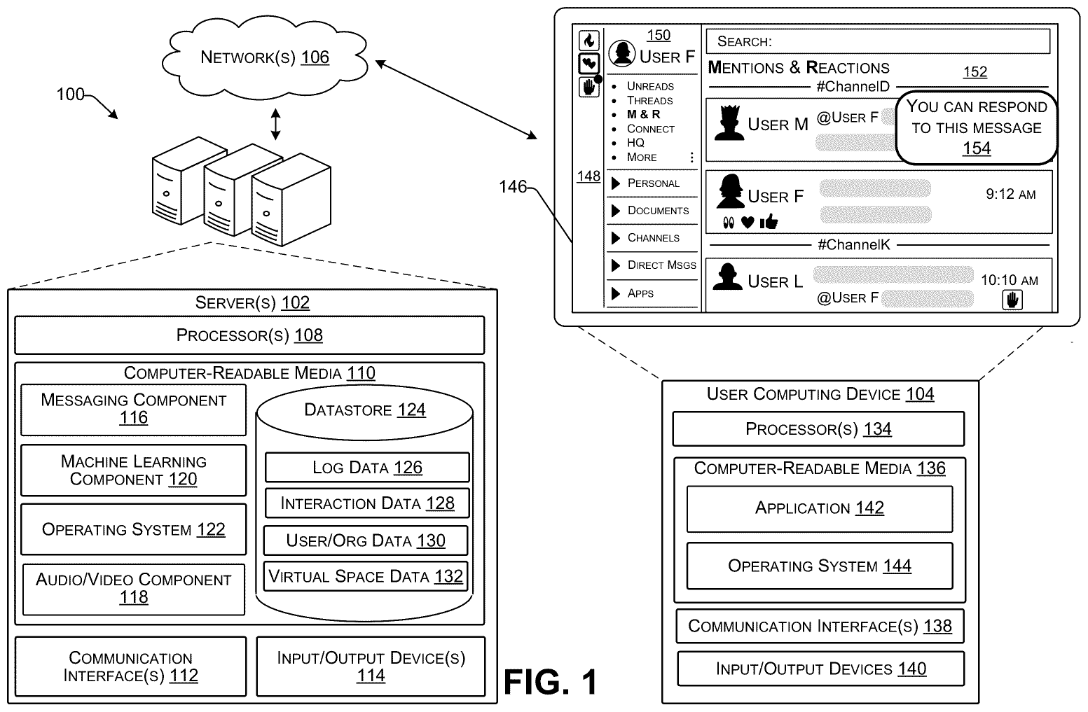

FIG. 1 illustrates an example environment 100 for performing techniques described herein. In at least one example, the example environment 100 can be associated with a communication platform that can leverage a network-based computing system to enable users of the communication platform to exchange data. In at least one example, the communication platform can be “group-based” such that the platform, and associated systems, communication channels, messages, collaborative documents, canvases, audio/video conversations, and/or other virtual spaces, have security (that can be defined by permissions) to limit access to a defined group of users. In some examples, such groups of users can be defined by group identifiers, as described above, which can be associated with common access credentials, domains, or the like. In some examples, the communication platform can be a hub, offering a secure and private virtual space to enable users to chat, meet, call, collaborate, transfer files or other data, or otherwise communicate between or among each other. As described above, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the example environment 100 can include one or more server computing devices (or “server(s)”) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device, e.g., portable, semi-portable, semi-stationary, or stationary. Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example environment 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, and/or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processors 108, computer-readable media 110, one or more communication interfaces 112, and input/output devices 114.

In at least one example, each processor of the processor(s) 108 can be a single processing unit or multiple processing units, and can include single or multiple computing units or multiple processing cores. The processor(s) 108 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media can optionally include a messaging component 116, an audio/video component 118, a machine learning component 120, an operating system 122, and a datastore 124.

In at least one example, the messaging component 116 can process messages between users. That is, in at least one example, the messaging component 116 can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. Additionally, the messages can be transmitted in association with a collaborative document, canvas, or other collaborative space. In at least one example, the canvas can include a flexible canvas for curating, organizing, and sharing collections of information between users. In at least one example, the collaborative document can be associated with a document identifier (e.g., virtual space identifier, communication channel identifier, etc.) configured to enable messaging functionalities attributable to a virtual space (e.g., a communication channel) within the collaborative document. That is, the collaborative document can be treated as, and include the functionalities associated with, a virtual space, such as a communication channel. The virtual space, or communication channel, can be a data route used for exchanging data between and among systems and devices associated with the communication platform.

In at least one example, the messaging component 116 can establish a communication route between and among various user computing devices, allowing the user computing devices to communicate and share data between and among each other. In at least one example, the messaging component 116 can manage such communications and/or sharing of data. In some examples, data associated with a virtual space, such a collaborative document, can be presented via a user interface. In addition, metadata associated with each message transmitted via the virtual space, such as a timestamp associated with the message, a sending user identifier, a recipient user identifier, a conversation identifier and/or a root object identifier (e.g., conversation associated with a thread and/or a root object), and/or the like, can be stored in association with the virtual space.

In various examples, the messaging component 116 can receive a message transmitted in association with a virtual space (e.g., direct message instance, communication channel, canvas, collaborative document, etc.). In various examples, the messaging component 116 can identify one or more users associated with the virtual space and can cause a rendering of the message in association with instances of the virtual space on respective user computing devices 104. In various examples, the messaging component 116 can identify the message as an update to the virtual space and, based on the identified update, can cause a notification associated with the update to be presented in association with a sidebar of user interface associated with one or more of the user(s) associated with the virtual space. For example, the messaging component 116 can receive, from a first user account, a message transmitted in association with a virtual space. In response to receiving the message (e.g., interaction data associated with an interaction of a first user with the virtual space), the messaging component 116 can identify a second user associated with the virtual space (e.g., another user that is a member of the virtual space). In some examples, the messaging component 116 can cause a notification of an update to the virtual space to be presented via a sidebar of a user interface associated with a second user account of the second user. In some examples, the messaging component 116 can cause the notification to be presented in response to a determination that the sidebar of the user interface associated with the second user account includes an affordance associated with the virtual space. In such examples, the notification can be presented in association with the affordance associated with the virtual space.

In various examples, the messaging component 116 can be configured to identify a mention or tag associated with the message transmitted in association with the virtual space. In at least one example, the mention or tag can include an @mention (or other special character) of a user identifier that is associated with the communication platform. The user identifier can include a username, real name, or other unique identifier that is associated with a particular user. In response to identifying the mention or tag of the user identifier, the messaging component 116 can cause a notification to be presented on a user interface associated with the user identifier, such as in association with an affordance associated with the virtual space in a sidebar of a user interface associated with the particular user and/or in a virtual space associated with mentions and reactions. That is, the messaging component 116 can be configured to alert a particular user that they were mentioned in a virtual space.

In at least one example, the audio/video component 118 can be configured to manage audio and/or video communications between and among users. In some examples, the audio and/or video communications can be associated with an audio and/or video conversation. In at least one example, the audio and/or video conversation can include a discrete identifier configured to uniquely identify the audio and/or video conversation. In some examples, the audio and/or video component 118 can store user identifiers associated with user accounts of members of a particular audio and/or video conversation, such as to identify user(s) with appropriate permissions to access the particular audio and/or video conversation.

In some examples, communications associated with an audio and/or video conversation (“conversation”) can be synchronous and/or asynchronous. That is, the conversation can include a real-time audio and/or video conversation between a first user and a second user during a period of time and, after the first period of time, a third user who is associated with (e.g., is a member of) the conversation can contribute to the conversation. The audio/video component 118 can be configured to store audio and/or video data associated with the conversation, such as to enable users with appropriate permissions to listen and/or view the audio and/or video data.

In some examples, the audio/video component 118 can be configured to generate a transcript of the conversation, and can store the transcript in association with the audio and/or video data. The transcript can include a textual representation of the audio and/or video data. In at least one example, the audio/video component 118 can use known speech recognition techniques to generate the transcript. In some examples, the audio/video component 118 can generate the transcript concurrently or substantially concurrently with the conversation. That is, in some examples, the audio/video component 118 can be configured to generate a textual representation of the conversation while it is being conducted. In some examples, the audio/video component 118 can generate the transcript after receiving an indication that the conversation is complete. The indication that the conversation is complete can include an indication that a host or administrator associated therewith has stopped the conversation, that a threshold number of meeting attendees have closed associated interfaces, and/or the like. That is, the audio/video component 118 can identify a completion of the conversation and, based on the completion, can generate the transcript associated therewith.

In at least one example, the audio/video component 118 can be configured to cause presentation of the transcript in association with a virtual space with which the audio and/or video conversation is associated. For example, a first user can initiate an audio and/or video conversation in association with a communication channel. The audio/video component 118 can process audio and/or video data between attendees of the audio and/or video conversation, and can generate a transcript of the audio and/or video data. In response to generating the transcript, the audio/video component 118 can cause the transcript to be published or otherwise presented via the communication channel. In at least one example, the audio/video component 118 can render one or more sections of the transcript selectable for commenting, such as to enable members of the communication channel to comment on, or further contribute to, the conversation. In some examples, the audio/video component 118 can update the transcript based on the comments.

In at least one example, the audio/video component 118 can manage one or more audio and/or video conversations in association with a virtual space associated with a group (e.g., organization, team, etc.) administrative or command center. The group administrative or command center can be referred to herein as a virtual (and/or digital) headquarters associated with the group. In at least one example, the audio/video component 118 can be configured to coordinate with the messaging component 116 and/or other components of the server(s) 102, to transmit communications in association with other virtual spaces that are associated with the virtual headquarters. That is, the messaging component 116 can transmit data (e.g., messages, images, drawings, files, etc.) associated with one or more communication channels, direct messaging instances, collaborative documents, canvases, and/or the like, that are associated with the virtual headquarters. In some examples, the communication channel(s), direct messaging instance(s), collaborative document(s), canvas(es), and/or the like can have associated therewith one or more audio and/or video conversations managed by the audio/video component 118. That is, the audio and/or video conversations associated with the virtual headquarters can be further associated with, or independent of, one or more other virtual spaces of the virtual headquarters.

In at least one example, the machine learning component 120 may be trained and then used to determine affordances for users. For example, to train the machine learning component 120, the server(s) 102 may use log data 126 representing interactions with users of the communication platform. As described herein, an interaction may include, but is not limited to, sending a message, sending a threshold number of messages (e.g., two messages, five messages, ten messages, etc.), receiving a message, receiving a threshold number of messages, opening a collaborative function associated with the communication platform, opening a document, opening the user interface, inputting an identifier of a member associated with a group, joining the communication platform (e.g., joining a communication channel, joining a workspace, etc.), utilizing the communication platform a specific number of times (e.g., one time, five, times, ten times, etc.), utilizing a feature of the communication platform a specific number of times (e.g., one time, five, times, ten times, etc.), utilizing the communication platform for a specific an amount of time (e.g., one hour, one day, one week, one month, etc.), utilizing a features of the communication platform for a specific amount of time (e.g., one hour, one day, one week, one month, etc.), responding to a message with a graphical element, joining an audio or video communication, initiating an audio or video communication, and/or the like.

In some examples, the log data 126 can be associated with one or more outcomes, including but not limited to, a performance of a group (e.g., based on metrics such as production, profits, subjective ratings (e.g., better, best, etc.), attributes of a group (e.g., the group has purchased certain features of the communication platform), and the like. Accordingly, certain interactions of the users can be associated with certain outcomes for the purposes of training the machine learning component 120.

The log data 126 may further indicate features that the users utilize when interacting with the communication platform. For a first example, the log data 126 may indicate that users that sent their fifth message using the communication platform (e.g., an interaction) finally started using a feature associated with messages, such as tools for changing the formatting of the message. For a second example, the log data 126 may indicate that a large number of users that join workspaces (e.g., an interaction) also use the feature for identifying other members of the workspaces. By way of another example, the log data 126 may implicitly or explicitly indicate which features that a group are not using.

In some examples, the log data 126 is associated with more than one group. For example, the log data 126 may represent interactions that members of more than one group performed while collaborating with one another using the communication platform. In some examples, the log data 126 is associated with a single group. For example, the log data 126 may represent the interactions that members of the group performed while collaborating with one another using the communication platform. Still, in some examples, the log data 126 is associated with similar types of users. For example, the log data 126 may represent the interactions that users, which the server(s) 102 determine as being similar to one another, performed while collaborating using the communication platform.

To train the machine learned component 120, the server(s) may input the log data 126 into the machine learned component 120. The machine learning component 120 may then analyze the log data 126 in order to determine relationships associated with features that were used by users when performing different types of interactions with the communication platform. For a first example, the machine learning component 120 may analyze the log data 126 in order to identify that a majority of users that send messages also use different tools for formatting the messages. As such, the machine learning component 120 may identify a relationship between sending messages (e.g., an interaction) and formatting messages using tools (e.g., a feature). For a second example, the machine learning component 120 may analyze the log data 126 in order to determine that a majority of users that send messages also include emojis within the messages. As such, the machine learning component 120 may identify a relationship between sending messages (e.g., an interaction) and adding emojis (e.g., a feature).

Additionally, in some examples, the machine learned component 120 may analyze the log data 126 in order to identify times that the users use features when performing the interactions with the communication platform. For a first example, the machine learning component 120 may analyze the log data 126 in order to identify that a majority of users use the tools for formatting messages after sending at least five messages. As such, the machine learning component 120 may identify a relationship between sending a fifth message (e.g., an interaction) and formatting messages using tools (e.g., a feature). For a second example, the machine learning component 120 may analyze the log data 126 in order to identify that a majority of users use the tools for formatting messages after using the communication platform for at least a week. As such, the machine learning component 120 may identify a relationship between using the communication platform for a week (e.g., an interaction) and formatting messages using tools (e.g., a feature).

While these are just a couple of examples of the machine learning component 120 determining relationships between interactions and features, in other examples, the machine learning component 120 may determine other relationships between interactions and features. In some examples, the machine learning component 120 may determine a relationship between an interaction and a feature based on a given number of users using the feature when performing the interaction. The given number of users may include, but is not limited to, one user, ten users, one hundred users, one thousand users, one million users, and/or any other number of users. In some examples, the machine learning component 120 may determine a relationship between an interaction and a feature based on a threshold percentage of users using the feature when performing the interaction. The threshold percentage of users may include, but is not limited to, ten percent, fifty percent, ninety percent, and/or any other percentage of users. In other words, the machine learning component 120 may analyze the log data 126 in order to determine the best time to provide affordances for different features.

As described above, the log data 126 may be associated with all users, users that are members of a group, similar types of users, and/or the like. As such, the server(s) 102 may train the machine learning component 120 to be specific to different types of users. For a first example, if the server(s) 102 train the machine learning component 120 using log data 126 that is associated with a group, then the machine learning component 120 may be specific to the members of the group. For a second example, if the server(s) train the machine learning component 120 using log data 126 that is associated with users that have purchased features associated with the communication platform and/or continued to use the communication platform for long periods of time, then the machine learning component 120 may be specific to members that frequently engage with the communication platform. In other words, the server(s) 102 are able to customize the machine learning component 120 for various types of users.

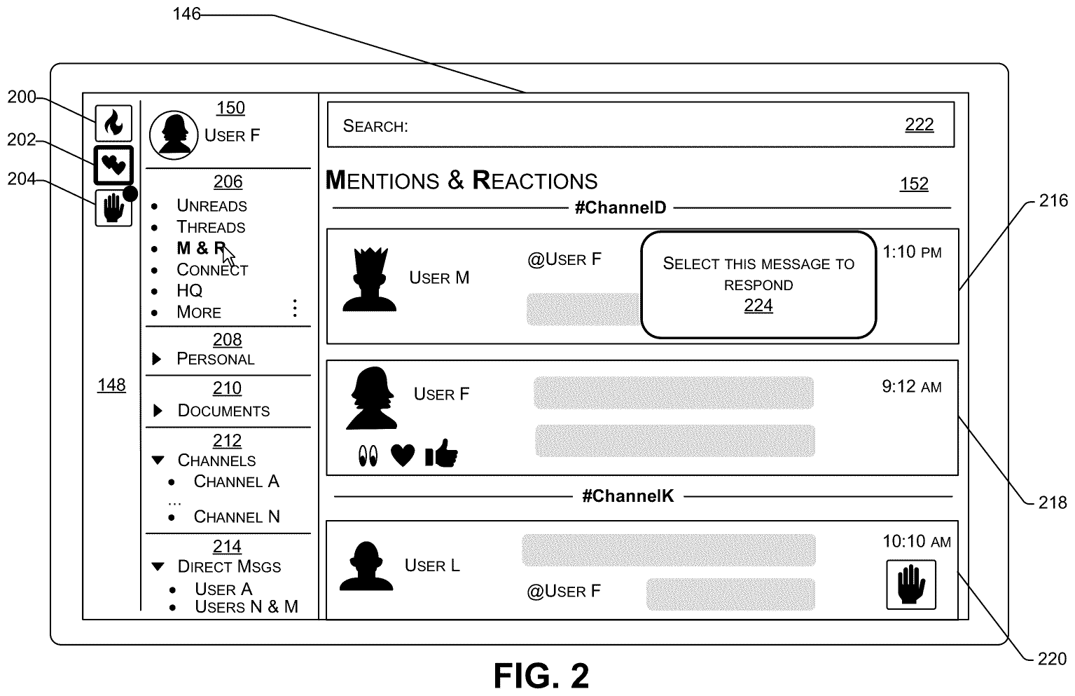

After training the machine learning component 120, the server(s) 102 may then use the machine learning component 120 in order to determine affordances to provide to users while utilizing the communication platform. As described herein, an affordance may include, but is not limited to, a prompt, a message, a notification, a graphic, content, an image, a video, an audio file, and/or the like that describes a feature. For a first example, an affordance may include a prompt that includes text that describes a feature. For a second example, an affordance may include an image representing how to use a feature. For a third example, an affordance may include a video depicting a user using a feature. Still, for a fourth example, an affordance may include an audio file representing one or more words describing how to use a feature. Examples of providing affordances are illustrated in at least FIGS. 2-4.

To determine an affordance for a user, the server(s) 102 may receive, from the user computing device 104, interaction data 128 representing an interaction for the user with the communication platform. The server(s) 102 may then analyze the interaction using the machine learning component 120 in order to determine the affordance. For a first example, the interaction may include the user drafting a message for another user. As such, the server(s) 102 may analyze the interaction using the machine learning component 120 in order to determine the affordance for the user. For instance, and using this first example, if a majority of users use tools for formatting messages, then the machine learning component 120 may have determined that there is a relationship between drafting messages and using formatting tools. As such, the machine learning component 120 may determine the affordance as describing features for formatting messages. For a second example, the interaction may include the user drafting his or her fifth message using the communication platform. As such, the server(s) 102 may again analyze the interaction using the machine learning component 120 in order to determine the affordance for the user. For instance, and using this second example, if a majority of the users of the communication platform do not format messages until sending at least five messages, then the machine learning component 120 may have identified a relationship between drafting a fifth message and using formatting tools. As such, the machine learning component 120 may determine the affordance as describing the feature for formatting messages.

In some examples, and as described above, the machine learning component 120 may be trained in order to be specific to a group of users and/or a type of users. This way, the machine learning component 120 is able to provide affordances that are more significant to a specific user. For a first example, the server(s) 102 may receive an interaction from a user that is a member of a group, where the interaction includes the user joining the group. The server(s) 102 may then analyze this interaction using a machine learning component 120 that has been trained using log data 126 associated with the group. For instance, and for this first example, if a majority of the members of the group join a workspace after initially joining the group, then the machine learning component 120 may determine an affordance that describes features associated with joining the workspace. This way, the user is able to better utilize the communication platform in order to participate with the other members of the group. In some examples, the server(s) 102 may provide this same affordance for all members of the group when the members perform similar interactions.

For a second example, the server(s) 102 may receive an interaction from a user that is new to the communication platform, where the interaction includes the user opening a user interface for the first time. The server(s) 102 may then analyze this interaction using a machine learning component 120 that has been trained using log data 126 associated with users that have purchased features associated with the communication platform and/or continued to use the communication platform for long periods of time. For instance, and for this second example, if a majority of these users tend to send messages when initially utilizing the communication platform while other users do not tend to send such messages, then the machine learning component 120 may determine an affordance that describes features associated with sending messages. This way, the machine learning component 120 may provide the user with features that will help keep the user engaged with the communication platform.

In some examples, aspects the machine learning component 120 discussed herein may include any models, techniques, and/or machine learned techniques. For example, in some examples, the machine learning component 120 may be implemented as a neural network. As described herein, an exemplary neural network is a technique which passes input data through a series of connected layers to produce an output. Each layer in a neural network may also comprise another neural network, or may comprise any number of layers (whether convolutional or not). As may be understood in the context of this disclosure, a neural network may utilize machine learning, which may refer to a broad class of such techniques in which an output is generated based on learned parameters.

Although discussed in the context of neural networks, any type of machine learning may be used consistent with this disclosure. For example, machine learning techniques may include, but are not limited to, regression techniques (e.g., ordinary least squares regression (OLSR), linear regression, logistic regression, stepwise regression, multivariate adaptive regression splines (MARS), locally estimated scatterplot smoothing (LOESS)), instance-based techniques (e.g., ridge regression, least absolute shrinkage and selection operator (LASSO), elastic net, least-angle regression (LARS)), decisions tree techniques (e.g., classification and regression tree (CART), iterative dichotomiser 3 (ID3), Chi-squared automatic interaction detection (CHAD), decision stump, conditional decision trees), Bayesian techniques (e.g., naïve Bayes, Gaussian naïve Bayes, multinomial naïve Bayes, average one-dependence estimators (AODE), Bayesian belief network (BNN), Bayesian networks), clustering techniques (e.g., k-means, k-medians, expectation maximization (EM), hierarchical clustering), association rule learning techniques (e.g., perceptron, back-propagation, hopfield network, Radial Basis Function Network (RBFN)), deep learning techniques (e.g., Deep Boltzmann Machine (DBM), Deep Belief Networks (DBN), Convolutional Neural Network (CNN), Stacked Auto-Encoders), Dimensionality Reduction Techniques (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Techniques (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc.

In at least one example, the operating system 122 can manage the processor(s) 108, computer-readable media 110, hardware, software, etc. of the server(s) 102.

In at least one example, the datastore 124 can be configured to store data that is accessible, manageable, and updatable. In some examples, the datastore 124 can be integrated with the server(s) 102, as shown in FIG. 1. In other examples, the datastore 124 can be located remotely from the server(s) 102 and can be accessible to the server(s) 102 and/or user device(s), such as the user device 104. The datastore 124 can comprise multiple databases, which can include the log data 126, the interaction data 128, user/org data 130 and/or virtual space data 132. Additional or alternative data may be stored in the data store and/or one or more other data stores.

In at least one example, the user/org data 130 can include data associated with users of the communication platform. In at least one example, the user/org data 130 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In at least one example, the user/org data 130 can include permission data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. Permissions associated with an individual user can be mapped to, or otherwise associated with, an account or profile within the user/org data 130. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In at least one example, the user/org data 130 can include data associated with one or more organizations of the communication platform. In at least one example, the user/org data 130 can store data in organization profiles, which can store data associated with an organization, including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

In at least one example, the virtual space data 132 can include data associated with one or more virtual spaces associated with the communication platform. The virtual space data 132 can include textual data, audio data, video data, images, files, and/or any other type of data configured to be transmitted in association with a virtual space. Non-limiting examples of virtual spaces include workspaces, communication channels, direct messaging instances, collaborative documents, canvases, and audio and/or video conversations. In at least one example, the virtual space data can store data associated with individual virtual spaces separately, such as based on a discrete identifier associated with each virtual space. In some examples, a first virtual space can be associated with a second virtual space. In such examples, first virtual space data associated with the first virtual space can be stored in association with the second virtual space. For example, data associated with a collaborative document that is generated in association with a communication channel may be stored in association with the communication channel. For another example, data associated with an audio and/or video conversation that is conducted in association with a communication channel can be stored in association with the communication channel.

As discussed above, each virtual space of the communication platform can be assigned a discrete identifier that uniquely identifies the virtual space. In some examples, the virtual space identifier associated with the virtual space can include a physical address in the virtual space data 132 where data related to that virtual space is stored. A virtual space may be “public,” which may allow any user within an organization (e.g., associated with an organization identifier) to join and participate in the data sharing through the virtual space, or a virtual space may be “private,” which may restrict data communications in the virtual space to certain users or users having appropriate permissions to view. In some examples, a virtual space may be “shared,” which may allow users associated with different organizations (e.g., entities associated with different organization identifiers) to join and participate in the data sharing through the virtual space. Shared virtual spaces (e.g., shared channels) may be public such that they are accessible to any user of either organization, or they may be private such that they are restricted to access by certain users (e.g., users with appropriate permissions) of both organizations.

In some examples, the datastore 124 can be partitioned into discrete items of data that may be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 124 that stores data related to a particular organization identification. For example, a database shard may store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared virtual space).

In some examples, individual groups can be associated with a database shard within the datastore 124 that stores data related to a particular group identification (e.g., workspace). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a virtual space can be associated with a database shard within the datastore 124 that stores data related to a particular virtual space identification. For example, a database shard may store electronic communication data associated with the virtual space, which enables members of that particular virtual space to communicate and exchange data with other members of the same virtual space in real time or near-real time. As discussed above, the communications via the virtual space can be synchronous and/or asynchronous. In at least one example, a group or organization can be the owner of the database shard and can control where and how the related data is stored.

In some examples, individual users can be associated with a database shard within the datastore 124 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via Websockets, Application Programming Interfaces (APIs) (e.g., using API calls), HyperText Transfer Protocols (HTTPs), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 134, computer-readable media 136, one or more communication interfaces 138, and input/output devices 140.

In at least one example, each processor of the processor(s) 134 can be a single processing unit or multiple processing units, and can include single or multiple computing units or multiple processing cores. The processor(s) 134 can comprise any of the types of processors described above with reference to the processor(s) 108 and may be the same as or different than the processor(s) 108.

The computer-readable media 136 can comprise any of the types of computer-readable media 136 described above with reference to the computer-readable media 110 and may be the same as or different than the computer-readable media 110. Functional components stored in the computer-readable media can optionally include at least one application 142 and an operating system 144.

In at least one example, the application 142 can be a mobile application, a web application, or a desktop application, which can be provided by the communication platform or which can be an otherwise dedicated application. In some examples, individual user computing devices associated with the environment 100 can have an instance or versioned instance of the application 142, which can be downloaded from an application store, accessible via the Internet, or otherwise executable by the processor(s) 134 to perform operations as described herein. That is, the application 142 can be an access point, enabling the user computing device 104 to interact with the server(s) 102 to access and/or use communication services available via the communication platform. In at least one example, the application 142 can facilitate the exchange of data between and among various other user computing devices, for example via the server(s) 102. In at least one example, the application 142 can present user interfaces, as described herein. In at least one example, a user can interact with the user interfaces via touch input, keyboard input, mouse input, spoken input, or any other type of input.

A non-limiting example of a user interface 146 is shown in FIG. 1. As illustrated in FIG. 1, the user interface 146 can present data associated with one or more virtual spaces, which may include one or more workspaces. That is, in some examples, the user interface 146 can integrate data from multiple workspaces into a single user interface so that the user (e.g., of the user computing device 104) can access and/or interact with data associated with the multiple workspaces that he or she is associated with and/or otherwise communicate with other users associated with the multiple workspaces. In some examples, the user interface 146 can include a first region 148, or pane, that includes indicator(s) (e.g., user interface element(s) or object(s)) associated with workspace(s) with which the user (e.g., account of the user) is associated. In some examples, the user interface 146 can include a second region 150, or pane, that includes indicator(s) (e.g., user interface element(s), affordance(s), object(s), etc.) representing data associated with the workspace(s) with which the user (e.g., account of the user) is associated. In at least one example, the second region 150 can represent a sidebar of the user interface 146. Additional details associated with the second region 150 and indicator(s) are described below with reference to FIG. 2.

In at least one example, the user interface 146 can include a third region 152, or pane, that can be associated with a data feed (or, “feed”) indicating messages posted to and/or actions taken with respect to one or more communication channels and/or other virtual spaces for facilitating communications (e.g., a virtual space associated with direct message communication(s), a virtual space associated with event(s) and/or action(s), etc.) as described herein. In at least one example, data associated with the third region 152 can be associated with the same or different workspaces. That is, in some examples, the third region 152 can present data associated with the same or different workspaces via an integrated feed. In some examples, the data can be organized and/or is sortable by workspace, time (e.g., when associated data is posted or an associated operation is otherwise performed), type of action, communication channel, user, or the like. In some examples, such data can be associated with an indication of which user (e.g., member of the communication channel) posted the message and/or performed an action. In examples where the third region 152 presents data associated with multiple workspaces, at least some data can be associated with an indication of which workspace the data is associated with. Additional details associated with the user interface 146, and the third region 152, are described below with reference to FIG. 2.

As further illustrated in FIG. 1, the user interface 146 may include an affordance 154 that describes a feature of the user interface 146. In the example of FIG. 1, the affordance 154 describes the feature that allows the user to respond to a message posted by another user (e.g., User M). However, in other examples, the affordance 154 may describe any other type of feature associated with the communication platform. Other examples will be illustrated in FIGS. 2-4.

In at least one example, the operating system 144 can manage the processor(s) 134, computer-readable media 136, hardware, software, etc. of the server(s) 102.

The communication interface(s) 138 can include one or more interfaces and hardware components for enabling communication with various other devices (e.g., the user computing device 104), such as over the network(s) 106 or directly. In some examples, the communication interface(s) 138 can facilitate communication via Websockets, APIs (e.g., using API calls), HTTPs, etc.

The user computing device 104 can further be equipped with various input/output devices 140 (e.g., I/O devices). Such I/O devices 140 can include a display, various user interface controls (e.g., buttons, joystick, keyboard, mouse, touch screen, etc.), audio speakers, connection ports and so forth.

While techniques described herein are described as being performed by the messaging component 116, the audio/video component 118, the machine learning component 120, and the application 142, techniques described herein can be performed by any other component, or combination of components, which can be associated with the server(s) 102, the user computing device 104, or a combination thereof.

FIG. 2 illustrates additional details associated with the user interface 146 that presents data associated with multiple workspaces, as described above with reference to FIG. 1.

As described above, in at least one example, the user interface 146 can include a first region 148, or pane, that includes indicator(s) (e.g., user interface element(s) or object(s)) of workspace(s) with which the user (e.g., account of the user) is associated. As illustrated in FIG. 2, the user (e.g., User F) can be associated with three different workspaces. In some examples, the workspaces can be associated with a same organization (e.g., associated with a same organization identifier). In some examples, one or more of the workspaces can be associated with different organizations (e.g., associated with different organization identifiers). In some examples, one of the workspaces can be associated with users from a single organization (e.g., associated with a same organization identifier) and another of the workspaces can be associated with users from two or more different organizations (e.g., associated with different organization identifiers).

In at least one example, each workspace can be associated with a different indicator 200-204, presented via the first region 148. In at least one example, a user account of the user (e.g., User F) can be associated with group identifiers that correspond to each of the workspaces (e.g., as determined by the user/org data 130 and/or the virtual space data 132). As such, the user account of the user can be associated with each of the workspaces. A first indicator 200 can represent a first workspace, a second indicator 202 can represent a second workspace, and a third indicator 204 can represent a third workspace.

In some examples, the user can navigate between the workspaces by actuating a control associated with each of the indicators 200-204 without needing to log out of one workspace and log in to each of the other workspaces. Non-limiting examples of such indicators, or any indictors described herein, can include icons, symbols, links, tabs, or other user interface elements or objects. In some examples, such indicators can be associated with actuation mechanisms to enable a user to select an indicator and transition to another workspace. In some examples, a visual indicator can indicate which workspace a user is currently interacting with and/or most recently interacted with. For example, the second indicator 202 is outlined in a heavier weight than the first indicator 200 and the third indicator 204, thereby indicating which workspace the user is currently interacting with and/or most recently interacted with. In some examples, the indicators 200-204 can be associated with another indicator indicating that the corresponding workspace has been updated. An example is shown with respect to the third indicator 204.

While three indicators 200-204 are illustrated in FIG. 2, the user can be associated with any number of workspaces. In some examples, indicators associated with all of the workspaces with which a user is associated can be presented via the first region 148. In some examples, some of the indicators associated with all of the workspaces with which a user is associated can be presented via the first region 148 and the user can interact with the user interface 146 to view additional or alternative indicators. In examples where fewer than all workspaces are represented via the user interface 146, the indicators can be arranged in alphabetical order, in an order of most recent interaction, in an order based on most frequent interaction, or some other order.

In some examples, the first region 148 may not be included in the user interface 146, and such information can be integrated into the user interface 146 via additional or alternative mechanisms.

In some examples, the user interface 146 can include a second region 150, or pane, that includes indicator(s) (e.g., user interface element(s) or object(s)) representing virtual space(s) associated with the workspace(s) with which the user (e.g., account of the user) is associated. In at least one example, the second region 150 can represent a sidebar of the user interface 146. In at least one example, the second region 150 can include one or more sub-sections, or sub-panes, which can represent different virtual spaces. For example, a first sub-section 206 can include indicators representing virtual spaces that can aggregate data associated with a plurality of virtual spaces of which the user is a member. In at least one example, each virtual space can be associated with an indicator in the first sub-section 206. In some examples, an indicator can be associated with an actuation mechanism (e.g., affordance) such that when actuated, can cause the application 142 to present data associated with the corresponding virtual space via the third region 152. In at least one example, a virtual space can be associated with all unread data associated with each of the workspaces with which the user is associated. That is, in some examples, if the user requests to access the virtual space associated with “unreads,” all data that has not been read (e.g., viewed) by the user can be presented in the third region 152, for example in a feed. In such examples, different types of events and/or actions, which can be associated with different virtual spaces, can be presented via a same feed. In some examples, such data can be organized and/or is sortable by associated virtual space (e.g., virtual space via which the communication was transmitted), time, type of action, user, and/or the like. In some examples, such data can be associated with an indication of which user (e.g., member of the associated virtual space) posted the message and/or performed an action.

In some examples, a virtual space can be associated with a same type of event and/or action. For example, “threads” can be associated with messages, files, etc. posted in threads to messages posted in a virtual space and “mentions and reactions” (e.g., “M & R”) can be associated with messages or threads where the user (e.g., User F) has been mentioned (e.g., via a tag) or another user has reacted (e.g., via an emoji, reaction, or the like) to a message or thread posted by the user. That is, in some examples, same types of events and/or actions, which can be associated with different virtual spaces, can be presented via a same feed. As with the “unreads” virtual space, data associated with such virtual spaces can be organized and/or is sortable by virtual space, time, type of action, user, and/or the like.

In some examples, a virtual space can be associated with facilitating communications between a user and other users of the communication platform. For example, “connect” can be associated with enabling the user to generate invitations to communicate with one or more other users. In at least one example, responsive to receiving an indication of selection of the “connect” indicator, the communication platform can cause a connections interface to be presented in the third region 152.

In some examples, a virtual space can be associated with a group (e.g., organization, team, etc.) headquarters (e.g., administrative or command center). In at least one example, the group headquarters can include a virtual or digital headquarters for administrative or command functions associated with a group of users. For example, “HQ” can be associated with an interface including a list of indicators associated with virtual spaces configured to enable associated members to communicate. In at least one example, the user can associate one or more virtual spaces with the “HQ” virtual space, such as via a drag and drop operation. That is, the user can determine relevant virtual space(s) to associate with the virtual or digital headquarters, such as to associate virtual space(s) that are important to the user therewith.

Though not illustrated, in some examples, a virtual space can be associated with one or more boards or collaborative documents with which the user is associated. In at least one example, a document can include a collaborative document configured to be accessed and/or edited by two or more users with appropriate permissions (e.g., viewing permissions, editing permissions, etc.). In at least one example, if the user requests to access the virtual space associated with one or more documents with which the user is associated, the one or more documents can be presented via the user interface 146 (e.g., in the third region 152). In at least one example, the documents, as described herein, can be associated with an individual (e.g., private document for a user), a group of users (e.g., collaborative document), and/or one or more communication channels (e.g., members of the communication channel rendered access permissions to the document), such as to enable users of the communication platform to create, interact with, and/or view data associated with such documents. In some examples, the collaborative document can be a virtual space, a board, a canvas, a page, or the like for collaborative communication and/or data organization within the communication platform. In at least one example, the collaborative document can support editable text and/or objects that can be ordered, added, deleted, modified, and/or the like. In some examples, the collaborative document can be associated with permissions defining which users of a communication platform can view and/or edit the document. In some examples, a collaborative document can be associated with a communication channel, and members of the communication channel can view and/or edit the document. In some examples, a collaborative document can be sharable such that data associated with the document is accessible to and/or interactable for members of the multiple communication channels, workspaces, organizations, and/or the like.

Additionally, though not illustrated, in some examples, a virtual space can be associated with one or more canvases with which the user is associated. In at least one example, the canvas can include a flexible canvas for curating, organizing, and sharing collections of information between users. That is, the canvas can be configured to be accessed and/or modified by two or more users with appropriate permissions. In at least one example, the canvas can be configured to enable sharing of text, images, videos, GIFs, drawings (e.g., user-generated drawing via a canvas interface), gaming content (e.g., users manipulating gaming controls synchronously or asynchronously), and/or the like. In at least one example, modifications to a canvas can include adding, deleting, and/or modifying previously shared (e.g., transmitted, presented) data. In some examples, content associated with a canvas can be sharable via another virtual space, such that data associated with the canvas is accessible to and/or rendered interactable for members of the virtual space.

In some examples, if the first sub-section 206 includes a user interface element representative of a virtual space associated with audio and/or video communications (e.g., conversations, multimedia clips (e.g., videos, audio files, stories, etc.), etc.) that is actuated by a user, audio and/or video data associated with the user, which can be associated with different audio and/or video conversations, multimedia clips, stories, and/or the like, can be presented via the third region 152. In some examples, such audio and/or video data can be presented via a feed. For the purpose of this discussion, audio and/or video data can correspond to audio and/or video content provided by a user associated with the communication platform.

In at least one example, the second region 150 of the user interface 146 can include a second sub-section 208, or sub-pane, that is a personalized sub-section associated with personal documents that are associated with the user account. In at least one example, the user can select personal documents to associate with the second sub-section 208, such as by dragging and dropping, pinning, or otherwise associating selected personal documents into the second sub-section 208. As discussed above, personal documents can include collaborative documents in which the user is a sole member. For example, a personal document can include a to do list, a document with saved items, and/or the like.

In at least one example, the second region 150 of the user interface 146 can include a third sub-section 210, or sub-pane, associated with collaborative documents that are associated with the user account of the user. That is, a “documents” sub-section can include affordances associated with one or more collaborative documents of which the user is a member. In various examples, the communication platform can determine one or more collaborative documents to be associated with the documents sub-section (e.g., third sub-section 210) based on one or more ranking criteria. That is, the communication platform can cause affordances associated with highest ranking collaborative documents of which the user is a member to be presented in the documents sub-section. In some examples, the user can pin or otherwise associate one or more collaborative documents with the third sub-section 210. For example, the user can drag an affordance or other indicator associated with a collaborative document to the third sub-section 210 and release the selected collaborative document therein. In response to the drag-and-drop action, the communication platform can associate the selected collaborative document with the third sub-section 210 and cause presentation of an affordance of the selected collaborative document therein.

In at least one example, a label or other indicator associated with the third sub-section 210 can include an affordance that, when selected by the user, causes a documents interface to be presented in the third region 152 of the user interface 146. In some examples, the documents interface can include one or more lists of collaborative document(s) with which the user account of the user is associated. For example, the documents interface can include a first list of personal collaborative documents associated with the user account and a second list of collaborative documents that include two or more members.

In at least one example, the second region 150 of the user interface 146 can include a fourth sub-section 212, or sub-pane, that includes indicators representing communication channels. In some examples, the communication channels can include public channels, private channels, shared channels (e.g., between groups or organizations), single workspace channels, cross-workspace channels, combinations of the foregoing, or the like. In some examples, the communication channels represented can be associated with a single workspace. In some examples, the communication channels represented can be associated with different workspaces (e.g., cross-workspace). In at least one example, if a communication channel is cross-workspace (e.g., associated with different workspaces), the user may be associated with both workspaces, or may only be associated with one of the workspaces. In some examples, the communication channels represented can be associated with combinations of communication channels associated with a single workspace and communication channels associated with different workspaces.

In some examples, the fourth sub-section 212 can depict all communication channels, or a subset of all communication channels, that the user has permission to access (e.g., as determined by the permission data). In such examples, the communication channels can be arranged alphabetically, based on most recent interaction, based on frequency of interactions, based on communication channel type (e.g., public, private, shared, cross-workspace, etc.), based on workspace, in user-designated sections, or the like. In some examples, the fourth sub-section 212 can depict all communication channels, or a subset of all communication channels, that the user is a member of, and the user can interact with the user interface 146 to browse or view other communication channels that the user is not a member of but are not currently displayed in the fourth sub-section 212. In some examples, different types of communication channels (e.g., public, private, shared, cross-workspace, etc.) can be in different sections of the fourth sub-section 212, or can have their own sub-regions or sub-panes in the user interface 146. In some examples, communication channels associated with different workspaces can be in different sections of the fourth sub-section 212, or can have their own regions or panes in the user interface 146.

In some examples, the indicators can be associated with graphical elements that visually differentiate types of communication channels. For example, Channel A is associated with a lock graphical element. As a non-limiting example, and for the purpose of this discussion, the lock graphical element can indicate that the associated communication channel, Channel A, is private and access thereto is limited, whereas another communication channel, Channel N, is public and access thereto is available to any member of an organization with which the user is associated. In some examples, additional or alternative graphical elements can be used to differentiate between shared communication channels, communication channels associated with different workspaces, communication channels with which the user is or is not a current member, and/or the like.

In at least one example, the second region 150 can include a fifth sub-section 214, or sub-pane, that can include indicators representative of communications with individual users or multiple specified users (e.g., instead of all, or a subset of, members of an organization). Such communications can be referred to as “direct messages.” That is, the fifth sub-section 214, or sub-pane, can include indicators representative of virtual spaces that are associated with private messages between one or more users.

Additionally, though not illustrated, the second region 150 can include a sub-section that is a personalized sub-section associated with a team of which the user is a member. That is, the “team” sub-section can include affordance(s) of one or more virtual spaces that are associated with the team, such as communication channels, collaborative documents, direct messaging instances, audio or video synchronous or asynchronous meetings, and/or the like. In at least one example, the user can associate selected virtual spaces with the team sub-section, such as by dragging and dropping, pinning, or otherwise associating selected virtual spaces with the team sub-section.

As described above, in at least one example, the user interface 146 can include a third region 152, or pane, that is associated with a feed indicating messages posted to and/or actions taken with respect to a virtual space (e.g., a virtual space associated with direct message communication(s), a virtual space associated with communication channel communication(s), a virtual space associated with collaborative document communication(s) (e.g., via a messaging or chat interface within a collaborative document), a virtual space associated with audio and/or video communications, etc.) for facilitating communications. As described above, in at least one example, data associated with the third region 152 can be associated with the same or different workspaces. That is, in some examples, the third region 152 can present data associated with the same or different workspaces via an integrated feed. In some examples, the data can be organized and/or is sortable by time, type of action, virtual space, user, or the like. In some examples, such data can be associated with an indication of which user posted the message and/or performed an action. In examples where the third region 152 presents data associated with multiple workspaces or other virtual spaces, at least some data can be associated with an indication of which workspace or other virtual space the data is associated with.

For example, in FIG. 2, the user (e.g., User F), can interact with the user interface 146 to view data associated with the virtual space corresponding to “mentions and reactions.” In FIG. 2, data associated with the virtual space can be associated with different communication channels and different workspaces. As illustrated, the data is organized by communication channel (e.g., #ChannelD and #ChannelK). Though this is not intended to be so limiting, and the data can be organized and/or sortable by virtual space, time, type of action, user, and/or the like. As illustrated, another user (e.g., User M) mentioned the user (e.g., User F) in a message, represented by the indicator 216 (e.g., a user interface element, object, etc.), which is associated with a communication channel (e.g., #ChannelD). The user (e.g., User F) also posted a message, represented by the indicator 218 (e.g., a user interface element, object, etc.), in the same communication channel. One or more other users reacted to the message, represented by the indicator 218, with an emoji. As such, indicators associated with both messages can be presented in the third region 152. Because the data is organized by virtual space, indicators associated with both messages are presented together. In at least one example, the communication channel (e.g., #ChannelD) can be associated with the second workspace (e.g., associated with the second indicator 202). In some examples, because the user is currently interacting with (or most recently interacted with) the second workspace, neither of the indicators 216 or 218 are associated with workspace indicators (e.g., the second indicator 202).

As illustrated, another user (e.g., User L) mentioned the user (e.g., User F) in a message, represented by the indicator 220 (e.g., a user interface element or object), which is associated with a communication channel (e.g., #ChannelK). As such, the indicator 220 can be presented in the third region 152. Because the data is organized by virtual space, the indicator 220 can be presented in a different position in the feed than the other indicators 216 and 218. In at least one example, the communication channel (e.g., #ChannelK) can be associated with the third workspace (e.g., associated with the third indicator 204). In some examples, because the user is currently interacting with (or most recently interacted with) the second workspace, the indicator 220 may include an indicator indicating that it is associated with the third workspace (e.g., the third indicator 204).

For purposes of this discussion, a “message” can refer to any electronically generated digital object provided by a user using the user computing device 104 and that is configured for display within a communication channel and/or other virtual space for facilitating communications (e.g., a virtual space associated with direct message communication(s), etc.) as described herein. A message may include any text, image, video, audio, or combination thereof provided by a user (using a user computing device). For instance, the user may provide a message that includes text, as well as an image and a video, within the message as message contents. In such an example, the text, image, and video would comprise the message. Each message sent or posted to a communication channel of the communication platform can include metadata comprising a sending user identifier, a message identifier, message contents, a group identifier, a communication channel identifier, or the like. In at least one example, each of the foregoing identifiers may comprise American Standard Code for Information Interchange (ASCII) text, a pointer, a memory address, or the like.

In some examples, a user can comment on a message in a “thread.” A thread can be a message associated with another message that is not posted to a communication channel, but instead is maintained within an object associated with the original message. Messages and/or threads can be associated with file(s), emoji(s), app(s), etc.

A communication channel or other virtual space can be associated with data and/or content other than messages, or data and/or content that is associated with messages. For example, non-limiting examples of additional data that can be presented via the third region 152 of the user interface 146 include collaborative documents (e.g., documents that can be edited collaboratively, in real-time or near real-time, etc.), audio and/or video data associated with a conversation, members added to and/or removed from the communication channel, file(s) (e.g., file attachment(s)) uploaded and/or removed from the communication channel), application(s) added to and/or removed from the communication channel, post(s) (data that can be edited collaboratively, in near real-time by one or members of a communication channel) added to and/or removed from the communication channel, description added to, modified, and/or removed from the communication channel, modifications of properties of the communication channel, etc.

In some examples, the third region 152 can comprise a feed associated with a single virtual space. In such examples, data associated with the virtual space can be presented via the feed. In at least one example, data associated with a virtual space can be viewable to at least some of the users of a group of users associated with a same group identifier, such as users with appropriate permissions to access the virtual space. In some examples, for members of a virtual space, the content of the virtual space (e.g., messaging communications) can be displayed to each member of the virtual space. For instance, a common set of group-based messaging communications can be displayed to each member of the virtual space such that the content of the virtual space (e.g., messaging communications) may not vary per member of the virtual space. In some examples, data associated with a virtual space can appear differently for different users (e.g., based on personal configurations, group membership, etc.).

As further illustrated in the example of FIG. 2, the user interface 146 is providing an affordance 224 that describes a feature of the user interface 146. In the example of FIG. 2, the affordance 224 is describing a feature that allows the user to respond to the message from User M. For example, the affordance 224 includes the text “Select this message to respond.” As such, if the user selects the message from User M, the user is then able to respond to the message. In some examples, the server(s) 102 may have provided the affordance 224 based on a detected interaction. For example, the interaction may have included the user receiving the message from User M. However, in other examples, the interaction may have included a different type of interaction.

While the example of FIG. 2 illustrates the affordance 224 as including a prompt with describing the feature, in other examples, the affordance 224 may include any other type of affordance described herein. For a first example, the affordance 224 may include audio that is output by the user computing device 104, wherein the audio represents words such as “Select the message from User M to respond.” For a second example, the affordance 224 may include an image that depicts how to respond to the message from User M. For a third example, the affordance 224 may include a video that depicts how to respond to the message from User M.

Additionally, the example of FIG. 2 illustrates the user computing device 104 rendering the affordance 224 on the user interface 146 and proximate to the feature for which the affordance 224 is describing. Specifically, the user computing device 104 is rendering the affordance 224 over a portion of the message. This way, the user is able to easily determine the feature for which the affordance 224 is describing. However, in other examples, the user computing device 104 may render the affordance 224 at a different location on the user interface 146. In such examples, the affordance 224 may still include an indicator, such as an arrow, that points to the feature.

In at least one example, the format of the individual virtual spaces may appear differently to different users. In some examples, the format of the individual virtual spaces may appear differently based on which workspace a user is currently interacting with or most recently interacted with. In some examples, the format of the individual virtual spaces may appear differently for different users (e.g., based on personal configurations, group membership, etc.).

In at least one example, the user interface 146 can include a search mechanism 222, wherein a user can input a search term and the server(s) 102 can perform a search associated with the communication platform. In some examples, the search can be performed across each workspace with which the user is associated, or the search can be restricted to a particular workspace, based on a user specification.

The user interface 146 is a non-limiting example of a user interface that can be presented via the user computing device 104 (e.g., by the application 142). In some examples, the application 142 can receive data from the messaging component 116, the audio/video component 118, and/or the machine learning component 120 and the application 142 can generate and present the user interface 146 based on the data. In other examples, the application 142 can receive data from the messaging component 116 and/or the audio/video component 118, and instructions for generating the user interface 146 from the messaging component 116, the audio/video component 118, and/or the machine learning component 120. In such an example, the application 142 can present the user interface 146 based on the instructions. Additional or alternative data can be presented via a user interface and additional or alternative configurations can be imagined.

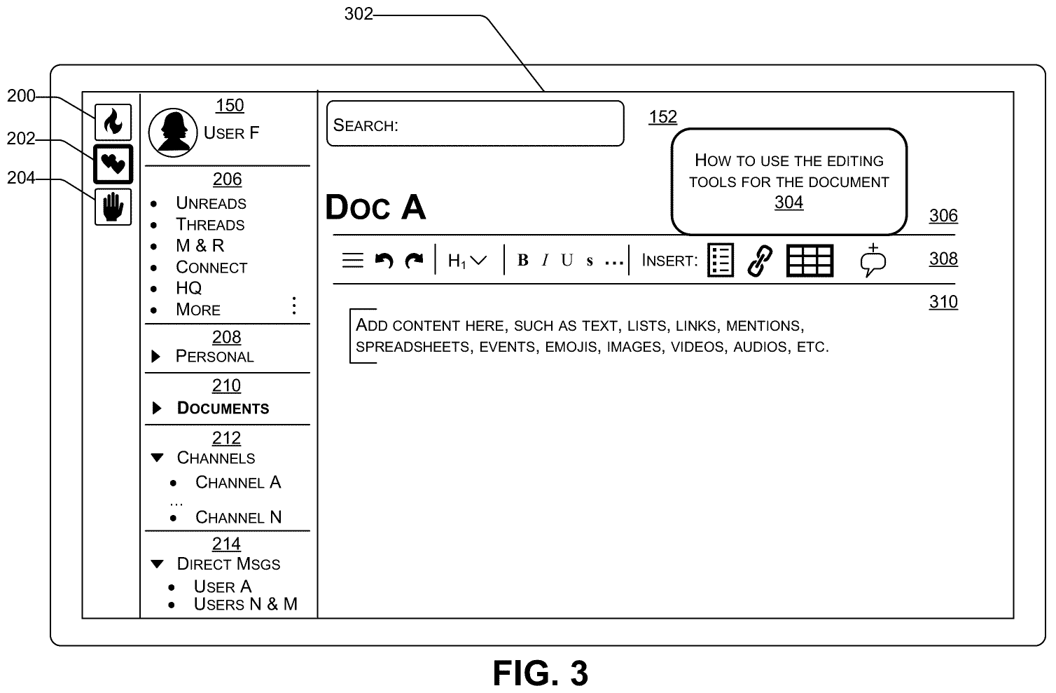

In examples of the present disclosure, an affordance may be used to indicate features associated with a user interface. For instance, and referring to FIG. 3, FIG. 3 shows an example documents interface 302 that includes an affordance 304. For instance, a user may use the document interface 302 in order to create, edit, collaborate, and/or the like with a document, such as within a group. As such, the document interface 302 may be presented in the third section 216 of the user interface 146. The document interface 302 may include various features that may be used by the user, such as a header section 306, an editing tools section 308, and a content section 310. Each of the features may be associated with various interface elements. For instance, and in the example of FIG. 3, the header section 306 may include a document title (e.g., “Doc A”) and a list of one or more linked virtual spaces (e.g., “#Linked Channel” and “#Virtual Space”).

The server(s) 102 may receive data indicating an interaction between the user and the document interface 302, such as the user editing the document. As such, the machine learning component 120 may analyze the interaction in order to determine the affordance 304 to provide with the document interface 302. For example, based on analyzing log data 126, the machine learning component 120 may identify a relationship between working on a document via the document interface 302 and using the editing tools from the editing tools section 308. As such, since the interaction includes the user working on the document, the machine learning component 120 may determine the affordance 304 to describe the features associated with the editing tools section 308.

As such, the server(s) 102 may cause the user interface 302 to provide the affordance 304 that provides details about using one or more of the editing tools included in the editing tools section 308. While the example of FIG. 3 illustrates the affordance 304 as including a prompt with text, in other examples, the affordance 304 may include any other type of affordance. Additionally, while the affordance 304 in the example of FIG. 3 includes text describing there are instructions describing how to use the one or more editing tools (e.g., “How to use the editing tools for the document”), in other examples, the affordance 304 may include the actual instructions. For example, the affordance 304 may include text that describes, “Select the Insert tool in order to add graphics to the document”.

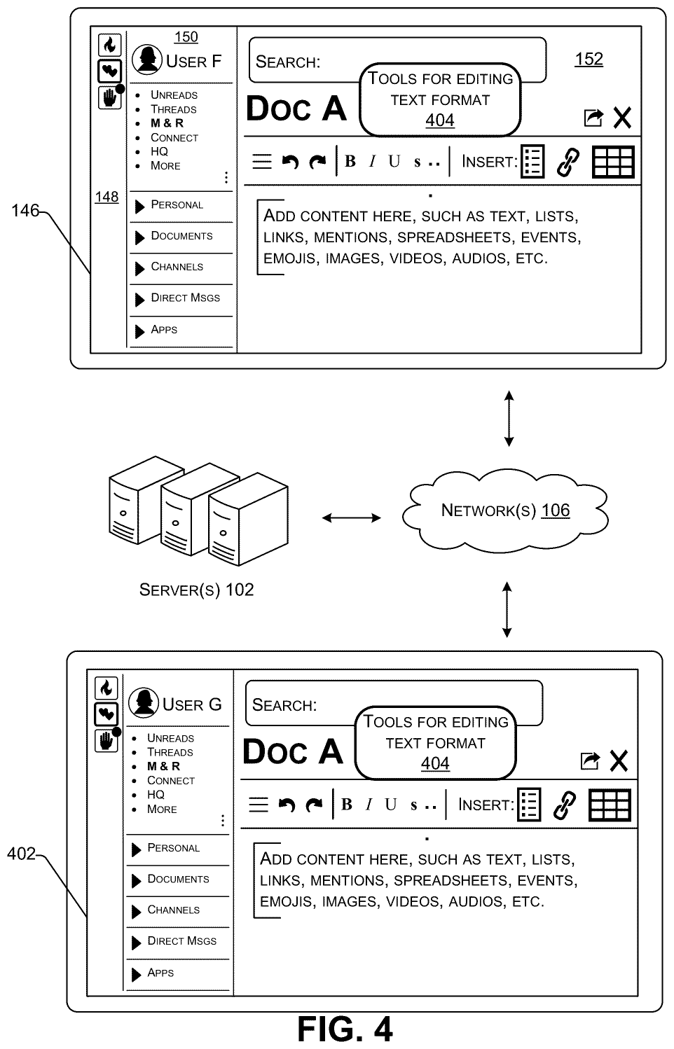

In examples of the present disclosure, an affordance may be provided to more than one member of a group. For instance, FIG. 4 illustrates example user interfaces 146, 402 associated with a communication platform, as described herein, where two members of a group are provided with a same affordance 404 while working in a collaborative space. In the example of FIG. 4, the members of the group may be working on a collaborative document. For instance, a first instance of the document may be presently open on the user computing device 104 of a first user, where the user computing device 104 is presenting the user interface 146, while a second instance of the document is presently open on a second user computing device (which may be similar to, and/or represented by, the user computing device 104) of a second user, wherein the second user computing device is presenting the user interface 402. As such, the first user is able to use the user interface 146 in order to interact with the document at a same time that the second user is using the second user interface 402 to interact with the document.

The server(s) 102 may receive data indicating a first interaction between the first user and the user interface 146 as well as receive data indicating a second interaction between the second user and the user interface 402. The machine learning component 120 may then analyze one or more of the interactions in order to determine the affordance 404 to provide to both the first user and the second user. For a first example, the machine learning component 120, during training using the log data 126, may have determined that there is a relationship between users interacting with a document (e.g., an interaction) and users using formatting tools for text (e.g., a feature). For a second example, the machine learning component 120, during training using the log data 126, may have determined that there is a relationship between members of a group that are concurrently interacting with a document (e.g., an interaction) and the members also using formatting tools for the text (e.g., a feature). Still, for a third example, the machine learning component 120, during training using the log data 126, may have determined that there is a relationship between members of a group, for which User F and User G are included, interacting with a document (e.g., an interaction) and the members also using formatting tools for the text (e.g., a feature). In either of the examples, the machine learning component 120 may determine the affordance 404 that describes the features related to the formatting tools for text.

The server(s) 102 may then cause both the user computing device 104 and the second user computing device to render the affordance 404. In some examples, the server(s) 102 cause both the user computing device 104 and the second user computing device to render the affordance 404 during a same period of time. This way, both the first user and the second user are provided with tips on using the same features when interacting with the document. In some examples, the server(s) 102 cause both the user computing device 104 and the second user computing device to render the affordance 404 while the first user and the second user are interacting with the document.

By way of example, and without limitation, the affordance 404 can include a message to initiate an audio and/or video conversation between Users F and G. For example, the machine learning component 120 can determine that the User F and/or User G has used such a communication in the past in connection with similar documents and can suggest using a particular feature in this instance. By way of another example and without limitation, the machine learning component 120 can present an affordance suggesting to invite another group or user to collaborate on a document, to add a feature to a document, and the like. In some examples, the machine learning component 120 can determine that particular features or interactions may not lead to desirable or positive outcomes and can suggest alternate actions instead.

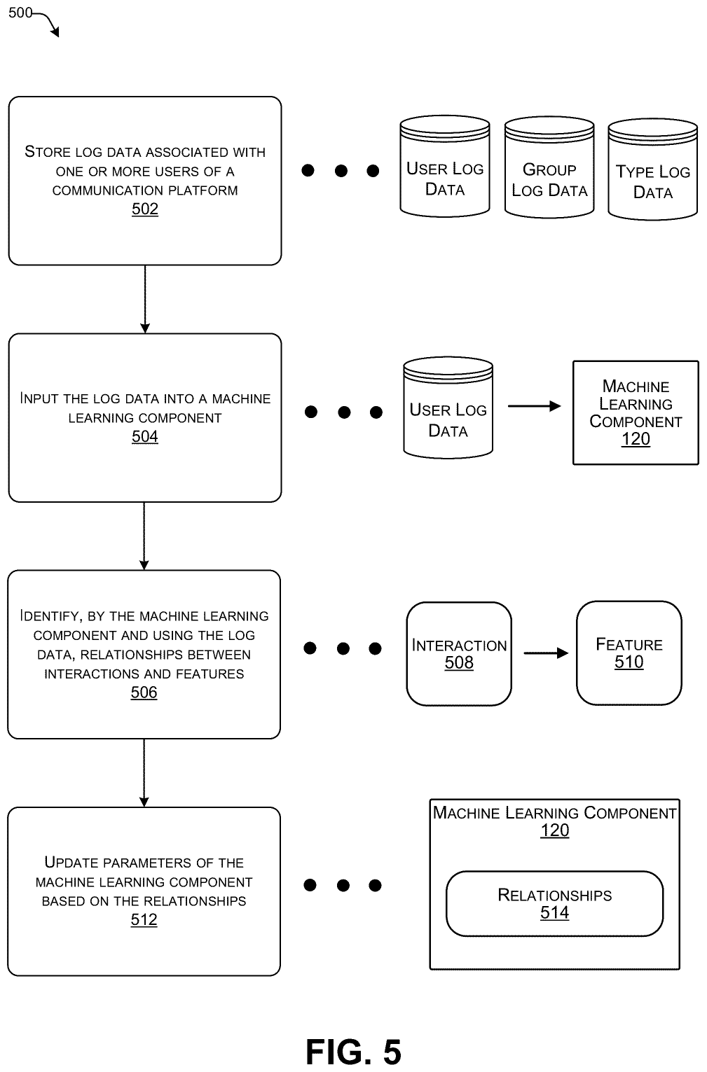

While the example of FIG. 5 illustrates providing the same affordance 404 to both users, in other examples, the server(s) 102 may only provide the affordance 404 to one of the users. For example, the server(s) 102 may store data representing a first experience associated with the first user and data representing a second experience associated with the second user. In some examples, an experience may indicate an amount of time that a user has accessed the communication platform. In some examples, an experience may indicate an amount of time that a user has had an account associated with the communication platform. In either example, the amount of time may include, but is not limited to, the number of seconds, minutes, hours, days, months, years, and/or the like. The server(s) 102 may then use the experiences when providing the affordance 404.

For example, if one of the users includes an experience that satisfies a threshold, then then the server(s) 102 may not provide the affordance 404 to that user. As described herein, the threshold may include a threshold amount of time, such as in seconds, minutes, hours, days, months, years, and/or the like. For example, the first experience for the first user may indicate that the first user has accessed the communication platform for one month, the second experience for the second user may indicate that the second user has accessed the communication platform for one year, and the threshold may include six months. As such, the server(s) 102 may cause the user computing device 104 to render the affordance 404, but not cause the second user computing device to render the affordance 404. In other words, the server(s) 102 may not provide affordances and/or specific affordances to users that have experience with the communication platform.

Referring to FIG. 5, an example process 500 is illustrated for training the machine learning component 120. In some instances, some or all of the process 500 may be performed by one or more components in the environment 100 or one or more components discussed with respect to FIGS. 1 and/or 2. However, the process 500 is not limited to being performed by the components in the environment 100, and the components in the environment 100 are not limited to performing the processes 500.

Referring to FIG. 5, in at least some examples, at operation 502, the process 500 includes storing log data associated with one or more users of a communication platform. For instance, the server(s) 102 may store the log data 126 associated with the one or more users. As illustrated in FIG. 5, the log data 126 may include at least user log data, group log data, and/or type log data. The user log data may represent interactions for one or more users of the communication platform, times that the interactions occurred, features used by the one or more users of the communication platform, times that the features were used, information about the one or more users (e.g., the user/org data 130), and/or the like. The group log data may be similar to the user log data, however, the group log data may be specific to one or more members associated with a group. Additionally, the type log data may also be similar to the user log data, however, the type log data may be specific to different types of users, which are described herein.

In some examples, at operation 504, the process 500 includes inputting the log data into a machine learning component. For instance, the server(s) 102 may input the log data 126 into the machine learning component 120. In some examples, when inputting the log data 126, the server(s) 102 customize the machine learning component 120 to specific groups of users. For a first example, the server(s) 102 may input the group log data into the machine learning component 120 in order to train the machine learning component 120 to be specific to a group. For a second example, the server(s) 102 may input the type log data into the machine learning component 120 in order to train the machine learning component 120 to be specific to a type of user. For instance, if the server(s) 102 want users to purchase one or more features associated with the communication platform, then the type log data input into the machine learning component 120 may be associated with users that have purchased different features. Additionally, if the server(s) 102 want to attempt to keep users as long-term users, then the type log data input into the machine learning component 120 may be associated with other long-term users of the communication platform.

In some examples, at operation 506, the process 500 includes identifying, by the machine learning component and using the log data, relationships between interactions and features. For instance, the machine learning components 120 may analyze the log data 126 in order to identify the relationships (represented by the arrow) between interactions 508 and features 510. As described herein, in some examples, the machine learning component 120 may identify a relationship between an interaction 508 and a feature 510 based on a given number of users using the feature when performing the interaction. The given number of users may include, but is not limited to, one user, ten users, one hundred users, one thousand users, one million users, and/or any other number of users. For example, if the machine learning component 120 determines that one million users of the communication platform begin to add emojis to messages after sending their fifth message, then the machine learning component 120 may identify a relationship between the interaction 508 of sending a fifth message and the feature 510 of adding emojis.

In some examples, the machine learning component 120 may determine a relationship between an interaction 508 and a feature 510 based on a threshold percentage of users using the feature when performing the interaction. The threshold percentage of users may include, but is not limited to, ten percent, fifty percent, ninety percent, and/or any other percentage of users. For example, if the machine learning component 120 determines that fifty percent of the members of a group begin to edit sent messages after sending their tenth message, then the machine learning component 120 may identify a relationship between the interaction 508 of sending a tenth message and the features 510 of editing the sent message.

In some examples, at operation 512, the process 500 includes updating the parameters of the machine learning component based on the relationships. For instance, the parameters of the machine learning component 120 may then be updated based at least on relationships 514 identified while analyzing the log data 126. The machine learning component 120 then uses these parameters in order to identify affordances when later analyzing interactions between users and the communication platform. In other words, the machine learning component 120 may be trained to determine affordances using the log data 126.

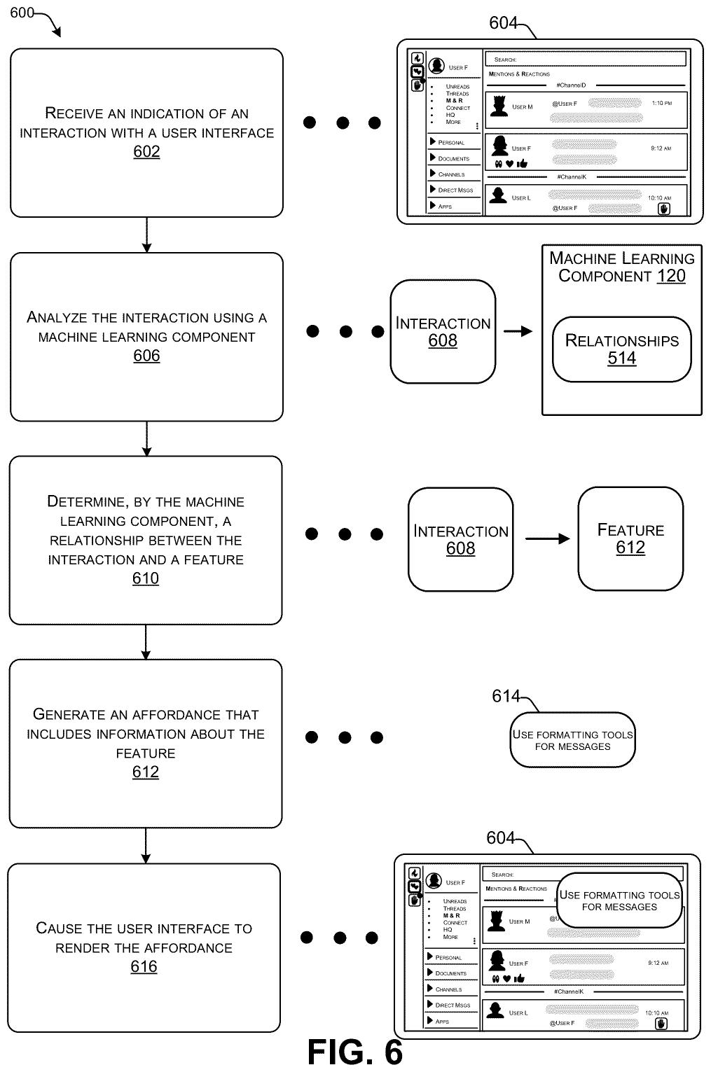

FIG. 6 illustrates an example process 600 for utilizing the machine learning component 120 to determine an affordance that includes information about a feature associated with a communication platform, as described herein. In some instances, some or all of the process 600 may be performed by one or more components in the environment 100 or one or more components discussed with respect to FIGS. 1 and/or 2. However, the process 600 is not limited to being performed by the components in the environment 100, and the components in the environment 100 are not limited to performing the processes 600.

In some examples, at operation 602, the process 600 includes receiving an indication of an interaction with a user interface. For instance, the server(s) 102 may receive data, from the user computing device 104, representing the interaction with a user interface 604. As described herein, the interaction may include, but is not limited to, sending a message, sending a threshold number of messages (e.g., two messages, five messages, ten messages, etc.), receiving a message, receiving a threshold number of messages, opening a collaborative function associated with the communication platform, opening a document, opening the user interface, inputting an identifier of a member associated with a group, joining the communication platform (e.g., joining a communication channel, joining a workspace, etc.), utilizing the communication platform a specific number of times (e.g., one time, five, times, ten times, etc.), utilizing a feature of the communication platform a specific number of times (e.g., one time, five, times, ten times, etc.), utilizing the communication platform for a specific an amount of time (e.g., one hour, one day, one week, one month, etc.), utilizing a features of the communication platform for a specific amount of time (e.g., one hour, one day, one week, one month, etc.), responding to a message with a graphical element, joining an audio or video communication, initiating an audio or video communication, and/or the like.

In some examples, at operation 606, the process 600 includes analyzing the interaction using a machine learning component. For instance, the server(s) 102 may analyze the interaction using the machine learning component 120. In some examples, to analyze the interaction 608, the server(s) 102 may input data representing the interaction into the machine learning component 120, where the data is represented by 608. As described herein, the machine learning component 120 is configured to determine relationships 514 between interactions and features.

For instance, and in some examples, at operation 610, the process 600 includes determining, by the machine learning component 120, a relationship between the interaction and a feature. For instance, based on analyzing the interaction, the machine learning component 120 may determine the relationship between the interaction and a feature 612, wherein the relationship is represented by the arrow. For a first example, if the machine learning component 120 determined that there is a relationship between drafting messages (e.g., an interaction) and using formatting tools (e.g., a feature) during training, and the interaction includes drafting a message, then the machine learning component 120 may determine the relationship between the drafting of the message and the using the formatting tools. For a second example, if the machine learning component 120 determined that there is a relationship between drafting a fifth message (e.g., an interaction) and using formatting tools (e.g., a feature) during training, and the interaction includes the user drafting a fifth message, then the machine learning component 120 may determine the relationship between the drafting of the fifth message and the using of the formatting tools.

In some examples, at operation 614, the process 600 includes generating an affordance that includes information about the feature. For instance, the server(s) 102 may generate an affordance 616 that includes the information describing the feature. As described herein, the affordance 616 may include, but is not limited to, a prompt, a message, a notification, a graphic, content, an image, a video, an audio file, and/or the like that describes a feature. For instance, and in the example of FIG. 6, the affordance 616 is a prompt that includes text (e.g., the information) that describes a feature.

In some examples, at operation 618, the process 600 includes causing the user interface to render the affordance. For instance, the server(s) 102 may cause the user interface 604 to render the affordance 616. In some examples, to cause the user interface 604 to render the affordance 616, the server(s) 102 may send, to the user computing device 104, data representing the affordance 616 and/or representing a command to render the affordance 616.

### Example Clauses

A: A method, implemented at least in part by one or more computing devices of a communication platform, the method comprising: receiving, from a client associated with a user account of the communication platform, an indication of an interaction associated with a user interface; analyzing the interaction using a machine learning component; based at least in part on analyzing the interaction, determining an affordance describing a feature associated with the user interface; and causing the client to render the affordance along with the user interface.

B: The method of paragraph A, further comprising: storing log data for a group for which the user account is associated, the log data representing interactions from members of the group; and training, using the log data, the machine learning component to select the affordance when the interaction occurs.

C: The method of either paragraph A or paragraph B, further comprising: storing log data associated with multiple groups of the communication platform, the log data representing interactions from members of the multiple groups; and training, using the log data, the machine learning component to select the affordance when the interaction occurs.

D: The method of any one of paragraphs A-C, further comprising: determining a time period that the user account has been at least one of active on the communication platform or associated with a group; and further analyzing the time period using the machine learning component, wherein determining the affordance is further based at least in part on analyzing the time period using the machine learning component.

E: The method of any one of paragraphs A-D, further comprising: receiving, from a second client associated with a second user account of the communication platform, an indication of a second interaction with a second user interface, wherein the user account and the second user account are associated with a group; further analyzing the second interaction using the machine learning component, wherein determining the affordance is further based at least in part on analyzing the second interaction using the machine learning component; and causing the second client to render the affordance along with the second user interface.

F: The method of any one of paragraphs A-E, further comprising: receiving, from the client associated with the user account, an indication of a second interaction associated with the user interface; analyzing the second interaction using the machine learning component; based at least in part on analyzing the second interaction using the machine learning component, determining a second affordance describing a second feature associated with the user interface; and causing the client to render the second affordance along with the user interface.

G: The method of any one of paragraphs A-F, further comprising: receiving, from the client associated with the user account, an indication of a second interaction associated with at least one of the feature or the affordance; and storing, in association with the user account, an indication that the feature is complete.

H: The method of any one of paragraphs A-G, further comprising: receiving, from a second client associated with a second user account of the communication platform, a second indication of a second interaction associated with a second user interface, the second interaction being similar to (or a same type as) the interaction; determining an experience associated with the second user account; and based at least in part on the experience, determining not to provide the affordance describing the feature to the second client.

I: A system comprising: one or more processors; and one or more computer-readable media storing instructions that, when executed by the one or more processors, cause the system to perform operations comprising: receiving, from a client associated with a user account of a communication platform, an indication of an interaction associated with a user interface; analyzing the interaction using a machine learning component; based at least in part on analyzing the interaction, determining an affordance describing a feature associated with the user interface; and causing the client to render the affordance along with the user interface.

J: The system of paragraph I, the operations further comprising: storing log data for a group for which the user account is associated, the log data representing interactions from members of the group; and training, using the log data, the machine learning component to select the affordance when the interaction occurs.

K: The system of either paragraph I or paragraph J, the operations further comprising: storing log data associated with multiple groups of the communication platform, the log data representing interactions from members of the multiple groups; and training, using the log data, the machine learning component to select the affordance when the interaction occurs.

L: The system of any one of paragraphs I-K, the operations further comprising: determining a time period that the user account has been at least one of active on the communication platform or associated with a group; and further analyzing the time period using the machine learning component, wherein determining the affordance is further based at least in part on analyzing the time period using the machine learning component.

M: The system of any one of paragraphs I-L, the operations further comprising: receiving, from a second client associated with a second user account of the communication platform, an indication of a second interaction with a second user interface, wherein the user account and the second user account are associated with a group; further analyzing the second interaction using the machine learning component, wherein determining the affordance is further based at least in part on analyzing the second interaction using the machine learning component; and causing the second client to render the affordance along with the second user interface.

N: The system of any one of paragraphs I-M, the operations further comprising: receiving, from the client associated with the user account, an indication of a second interaction associated with the user interface; analyzing the second interaction using the machine learning component; based at least in part on analyzing the second interaction using the machine learning component, determining a second affordance describing a second feature associated with the user interface; and causing the client to render the second affordance along with the user interface.

O: The system of any one of paragraphs I-N, the operations further comprising: receiving, from the client associated with the user account, an indication of a second interaction associated with at least one of the feature or the affordance; and storing, in association with the user account, an indication that the feature is complete.

P: The system of any one of paragraphs I-O, the operations further comprising: receiving, from a second client associated with a second user account of the communication platform, a second indication of a second interaction associated with a second user interface, the second interaction being similar to (or a same type as) the interaction; determining an experience associated with the second user account; and based at least in part on the experience, determining not to provide the affordance describing the feature to the second client.

Q: One or more computer-readable media storing instructions that, when executed by one or more processors, cause the one or more processors to perform operations comprising: receiving, from a client associated with a user account of a communication platform, an indication of an interaction associated with a user interface; analyzing the interaction using a machine learning component; based at least in part on analyzing the interaction, determining an affordance describing a feature associated with the user interface; and causing the client to render the affordance along with the user interface.

R: The one or more computer-readable media of paragraph Q, the operations further comprising: storing log data for a group for which the user account is associated, the log data representing interactions from members of the group; and training, using the log data, the machine learning component to select the affordance when the interaction occurs.

S: The one or more computer-readable media of either paragraph Q or paragraph R, the operations further comprising: storing log data associated with multiple groups of the communication platform, the log data representing interactions from members of the multiple groups; and training, using the log data, the machine learning component to select the affordance when the interaction occurs.

T: The one or more computer-readable media of any one of paragraphs Q-S, the operations further comprising: determining a time period that the user account has been at least one of active on the communication platform or associated with a group; and further analyzing the time period using the machine learning component, wherein determining the affordance is further based at least in part on analyzing the time period using the machine learning component.

What is claimed is:

1. A method, implemented at least in part by one or more computing devices of a communication platform, the method comprising:
receiving, from a client associated with a user account of the communication platform, an indication of an interaction associated with a user interface;
analyzing the interaction using a machine learning component;
based at least in part on analyzing the interaction, determining an affordance describing a feature associated with the user interface; and
causing the client to render the affordance along with the user interface.

2. The method of claim 1, further comprising:
storing log data for a group for which the user account is associated, the log data representing interactions from members of the group; and
training, using the log data, the machine learning component to select the affordance when the interaction occurs.

3. The method of claim 1, further comprising:
storing log data associated with multiple groups of the communication platform, the log data representing interactions from members of the multiple groups; and
training, using the log data, the machine learning component to select the affordance when the interaction occurs.

4. The method of claim 1, further comprising:
determining a time period that the user account has been at least one of active on the communication platform or associated with a group; and
further analyzing the time period using the machine learning component,
wherein determining the affordance is further based at least in part on analyzing the time period using the machine learning component.

5. The method of claim 1, further comprising:
receiving, from a second client associated with a second user account of the communication platform, an indication of a second interaction with a second user interface, wherein the user account and the second user account are associated with a group;
further analyzing the second interaction using the machine learning component, wherein determining the affordance is further based at least in part on analyzing the second interaction using the machine learning component; and
causing the second client to render the affordance along with the second user interface.

6. The method of claim 1, further comprising:
receiving, from the client associated with the user account, an indication of a second interaction associated with the user interface;
analyzing the second interaction using the machine learning component;
based at least in part on analyzing the second interaction using the machine learning component, determining a second affordance describing a second feature associated with the user interface; and
causing the client to render the second affordance along with the user interface.

7. The method of claim 1, further comprising:
receiving, from the client associated with the user account, an indication of a second interaction associated with at least one of the feature or the affordance; and
storing, in association with the user account, an indication that the feature is complete.

8. The method of claim 1, further comprising:
receiving, from a second client associated with a second user account of the communication platform, a second indication of a second interaction associated with a second user interface, the second interaction being a same type as the interaction;
determining an experience associated with the second user account; and
based at least in part on the experience, determining not to provide the affordance describing the feature to the second client.

9. A system comprising:
one or more processors; and
one or more computer-readable media storing instructions that, when executed by the one or more processors, cause the system to perform operations comprising:
receiving, from a client associated with a user account of a communication platform, an indication of an interaction associated with a user interface;
analyzing the interaction using a machine learning component;
based at least in part on analyzing the interaction, determining an affordance describing a feature associated with the user interface; and
causing the client to render the affordance along with the user interface.

10. The system of claim 9, the operations further comprising:
storing log data for a group for which the user account is associated, the log data representing interactions from members of the group; and
training, using the log data, the machine learning component to select the affordance when the interaction occurs.

11. The system of claim 9, the operations further comprising:
storing log data associated with multiple groups of the communication platform, the log data representing interactions from members of the multiple groups; and
training, using the log data, the machine learning component to select the affordance when the interaction occurs.

12. The system of claim 9, the operations further comprising:
determining a time period that the user account has been at least one of active on the communication platform or associated with a group; and
further analyzing the time period using the machine learning component,
wherein determining the affordance is further based at least in part on analyzing the time period using the machine learning component.

13. The system of claim 9, the operations further comprising:
receiving, from a second client associated with a second user account of the communication platform, an indication of a second interaction with a second user interface, wherein the user account and the second user account are associated with a group;
further analyzing the second interaction using the machine learning component, wherein determining the affordance is further based at least in part on analyzing the second interaction using the machine learning component; and
causing the second client to render the affordance along with the second user interface.

14. The system of claim 9, the operations further comprising:
receiving, from the client associated with the user account, an indication of a second interaction associated with the user interface;
analyzing the second interaction using the machine learning component;
based at least in part on analyzing the second interaction using the machine learning component, determining a second affordance describing a second feature associated with the user interface; and
causing the client to render the second affordance along with the user interface.

15. The system of claim 9, the operations further comprising:
receiving, from the client associated with the user account, an indication of a second interaction associated with at least one of the feature or the affordance; and
storing, in association with the user account, an indication that the feature is complete.

16. The system of claim 9, the operations further comprising:
receiving, from a second client associated with a second user account of the communication platform, a second indication of a second interaction associated with a second user interface, the second interaction being a same type as the interaction;
determining an experience associated with the second user account; and
based at least in part on the experience, determining not to provide the affordance describing the feature to the second client.

17. One or more computer-readable media storing instructions that, when executed by one or more processors, cause the one or more processors to perform operations comprising:
receiving, from a client associated with a user account of a communication platform, an indication of an interaction associated with a user interface;
analyzing the interaction using a machine learning component;
based at least in part on analyzing the interaction, determining an affordance describing a feature associated with the user interface; and
causing the client to render the affordance along with the user interface.

18. The one or more computer-readable media of claim 17, the operations further comprising:
storing log data for a group for which the user account is associated, the log data representing interactions from members of the group; and
training, using the log data, the machine learning component to select the affordance when the interaction occurs.

19. The one or more computer-readable media of claim 17, the operations further comprising:
storing log data associated with multiple groups of the communication platform, the log data representing interactions from members of the multiple groups; and
training, using the log data, the machine learning component to select the affordance when the interaction occurs.

20. The one or more computer-readable media of claim 17, the operations further comprising:
determining a time period that the user account has been at least one of active on the communication platform or associated with a group; and
further analyzing the time period using the machine learning component,
wherein determining the affordance is further based at least in part on analyzing the time period using the machine learning component.
